(19) United States
(12) Patent Application Publication
(10) Pub. No.: US 2004/0244604 A1
(43) Pub. Date: Dec. 9, 2004

(54) Protective food cover

(76) Inventor: Lisa K. Slagter, San Diego, CA (US)

Correspondence Address: NEIL K. NYDEGGER, NYDEGGER & ASSOCIATES, 348 Olive Street, San Diego, CA, 92103, US

(21) Appl. No.: 10/453,153

(22) Filed: Jun. 3, 2003

(51) Int. Cl. A23L 1/00

(52) U.S. Cl. 99/485

(57) ABSTRACT

A protective food product cover includes a hollow sidewall that is covered at one end by a support member to create an enclosure. The support member is formed with cross-slits. Further, the sidewall is engageable with a tray to protect the food product (e.g. a cake) from contamination, while it is carried on the tray in the enclosure. A plastic sheet is affixed to the support member to create a hermetic seal for the cover. In use, the plastic sheet is removed to expose the cross-slits on the support member. Candles are then inserted into the cross-slits and lit for a celebration. Subsequently, the sidewall, support member and candles are removed from the tray for access to the food product.

### FIELD OF THE INVENTION

The present invention pertains generally to food storage items. More particularly, the present invention pertains to covers which can be used for commercially prepared food products when the food products are to be subsequently decorated with celebratory candles. The present invention is particularly, but not exclusively, useful for protecting a food product (e.g. a cake) from contamination as burning celebratory candles presented with the food product are blown out by the consumer.

### BACKGROUND OF THE INVENTION

A well known, enjoyable and meaningful tradition that is associated with occasions such as anniversaries and birthdays involves the placement of lighted candles on cakes or pastries. Specifically, this is frequently done when the cake is being presented to an honoree(s) during a celebration. Typically, as part of the celebration, after the cake has been presented the honoree blows out the lighted candle(s). Although this is normally harmless, with the increased awareness of communicable airborne diseases, and for other obvious reasons, the act of “blowing out” candles on a cake may raise concerns among those who wish to subsequently eat the cake.

In recent years, advancements in food preparation techniques have allowed a wide variety of commercial food products to be prepared and packaged for mass consumption. Included here are food items such as anniversary and birthday cakes. Importantly, the procedures and techniques for packaging such food items have developed to the point where both the integrity and freshness of the food product can be protected for extended periods of time, prior to sale. Heretofore, whenever pre-baked cakes have been presented at parties or celebrations with lighted candles, it has been necessary to somehow remove the cake from the packaging.

In light of the above, it is an object of the present invention to provide a protective food product cover that protects the food product (cake) from contamination as lighted candles held on the cover are being “blown out”. Another object of the present invention is to provide a protective food product cover for preserving the freshness of the food product prior to its celebratory presentation with lighted candles. Yet another object of the present invention is to provide a protective food product cover for supporting celebratory candles on the food product which is easy to use, simple to manufacture, and comparatively cost effective.

### SUMMARY OF THE INVENTION

In accordance with the present invention, a protective food product cover is used to support at least one candle when the food product is presented at a celebration. As intended for the present invention, the cover includes a hollow sidewall having a top end and a bottom end, and it also has a support member that covers the top end of the sidewall to create an enclosure. Importantly, the support member is formed with a plurality of cross-slits. Specifically, these cross-slits are dimensioned to receive a candle therethrough, and to then hold the candle on the support member during the celebration, as desired.

Also included in the present invention is a tray that is provided for carrying the food product. In combination, the bottom end of the sidewall is engageable with the tray to confine the food product within the enclosure that is created by the sidewall and the support member. With this engagement, the food product is protected from contamination while it is in the enclosure.

An additional component of the present invention is a sealing sheet that is removably affixed to the support member. Specifically, the sealing sheet preferably includes an adhesive that will hold the sheet against the support member to cover the cross-slits. Thus, the sealing sheet provides an hermetic seal for the food product in the enclosure until it (the sealing sheet) is removed.

For an alternate embodiment of the present invention, the food product cover is provided with a base member. Specifically, for this embodiment, the base member is connected to the sidewall in a manner that positions the base member between the support member and the enclosure. Also, the base member is positioned substantially parallel to the support member with a distance between the base member and the support member that is only about one eighth of an inch. With this structure, in addition to providing an hermetic seal, the base member will also provide a platform for supporting candles while they are held in the cross-slits. Further, it will be appreciated that the sealing sheet can also be used with this embodiment.

As an additional feature for the food product cover of the present invention, the cover can include a plurality of tubular shaped sleeves. In detail, these sleeves will each have a respective lumen for receiving a portion of a candle. The sleeve on the candle will then prevent any shaving of the candle that might otherwise be caused when the candle is inserted into one of the cross-slits in the support member.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the food product cover of the present invention, shown with a cake (food product) positioned in its enclosure, and with burning candles being presented with the cake for a celebration;

FIG. 2 is an exploded perspective view of the present invention showing its constituent components;

FIG. 3 is a perspective view of the food product cover showing a partially removed hermetic sealing sheet;

FIG. 4 is a cross-sectional view of a food product cover as seen along the line 4-4 in FIG. 2; and

FIG. 5 is an exploded perspective view of a candle with a protective sleeve.

### DESCRIPTION OF THE PREFERRED EMBODIMENTS

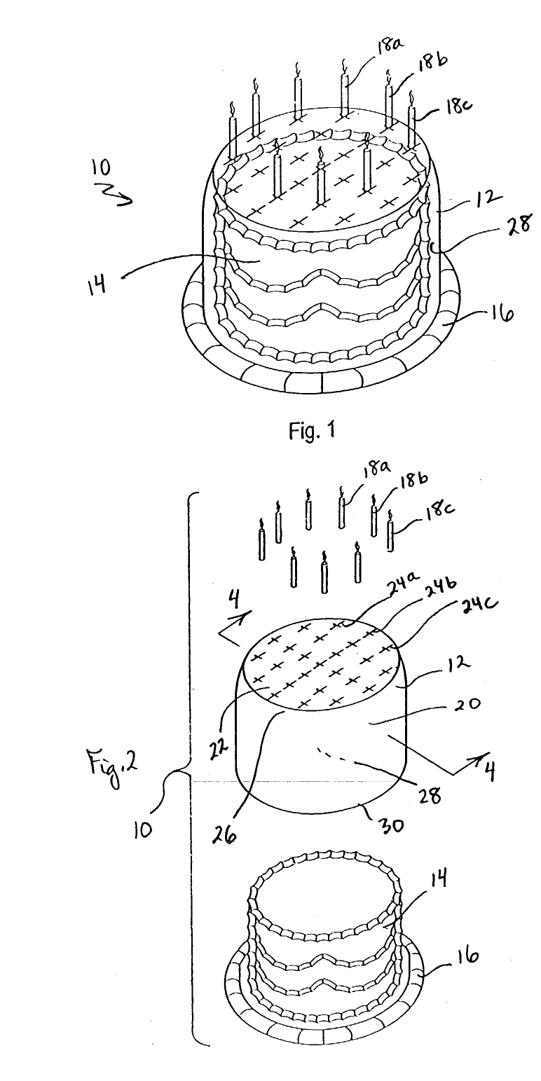

Referring initially to FIG. 1 a party presentation that incorporates the present invention is shown, and generally designated 10. In detail, by cross referencing FIG. 1 with FIG. 2, it will be seen that the presentation 10 includes a food product cover 12 that is dimensioned to shelter and protect a cake (food product) 14 while the cake (food product) 14 is being held or carried on a tray 16. Additionally, as shown in FIG. 1, a plurality of candles 18 can be selectively engaged with the cover 12. The candles 18a, 18b and 18c, however, are only exemplary for, as we know, the number of candles 18 that may be required for a birthday celebration may far exceed only three. The details of the cover 12 will, perhaps, be best appreciated with reference to FIG. 2.

In FIG. 2 it can be seen that the cover 12 includes a sidewall 20 that is integrally connected to a support member 22. Typically, the sidewall 20 will be shaped to conform with the shape of the cake (food product) 14. Thus, the sidewall 20 may be circular, or rectangular, or otherwise shaped, as desired. Accordingly, the support member 22 will be shaped to conform with the sidewall 20. Further, as shown, the support member 22 is formed with a plurality of cross-slits 24, of which the cross-slits 24a, 24b and 24c are only exemplary. As intended for the present invention, these cross-slits 24 are made by cuts that extend through the support member 22, and are dimensioned so that a candle 18 can be inserted through the cross-slit 24. The portions of the cross-slit 24 that are deflected by the inserted candle 18 then urge against the candle 18 to hold it on the support member 22.

As also shown in FIG. 2, the support member 22 is connected to the top end 26 of the sidewall 20. This creates an enclosure 28 that is dimensioned for receiving the cake (food product) 14 therein as the cake (food product) 14 is being held or carried on the tray 16. Still referring to FIG. 2, it will be appreciated that the bottom end 30 of the cover 12 can be engaged with the tray 16. Specifically, this engagement may be made in any manner well known in the pertinent art that will establish an hermetic seal between the cover 12 and the tray 16.

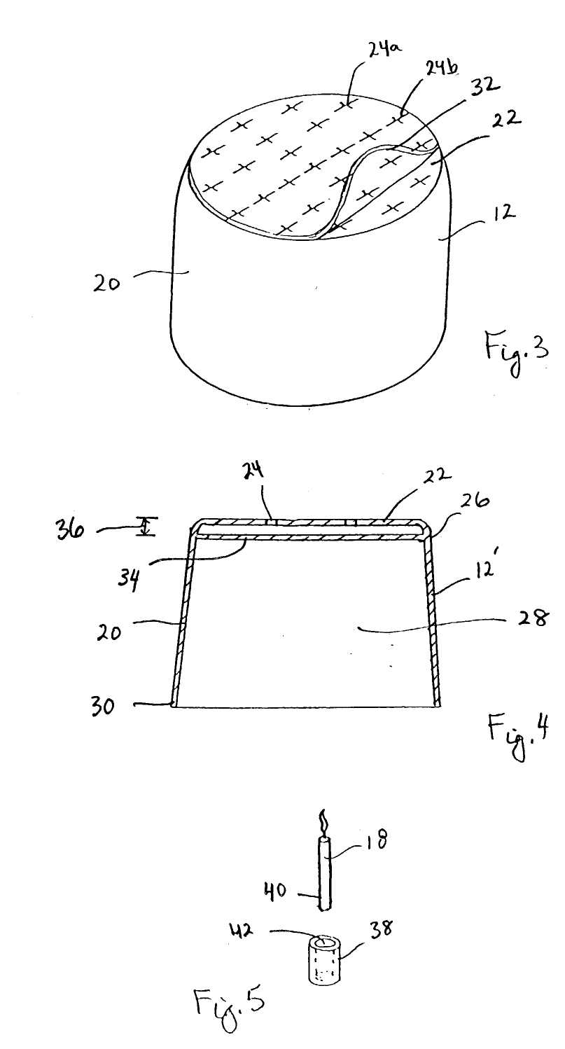

To help establish an hermetic seal for the enclosure 28, FIG. 3 shows that a flexible plastic sheet 32 can be placed on the support member 22 to cover the cross-slits 24. Preferably, as indicated in FIG. 3, this sheet 32 includes an adhesive (not shown) which will hold the sheet 32 in place on the support member 22 until the removal of the sheet 32 is desired. Upon removal of the sheet 32, the cross-slits 24 are then exposed to receive the candles 18 as mentioned above.

For an alternate embodiment for the present invention (shown in FIG. 4), a cover 12′ is provided which includes a base member 34. More specifically, as shown in FIG. 4, the base member 34 is integrally connected to the sidewall 20 and is positioned inside the enclosure 28 substantially parallel to the support member 22. Further, the base member 34 is preferably located at a distance 36 below the support member 22 that is only about one eighth of an inch. With this combination, in addition to creating an hermetic seal by isolating the cross-slits 24 from the enclosure 28, the base member 34 also provides a platform that will help stabilize the candles 18 after they have been inserted into, and are being held by, the cross-slits 24. Additionally, the base member 34 will prevent shavings off the candles 18 from falling into the enclosure 28 and onto the cake (food product) 14 as the candles 18 are being inserted into their respective cross-slits 24. Although the base member 34, itself, can establish an hermetic seal for the enclosure 28, it will be appreciated that the plastic sheet 32 can also be employed with the cover 12′ for this purpose.

An accessory for use with the present invention is a sleeve 38, shown in FIG. 5. Specifically, in use, the sleeve 38 can be positioned around the candle 18 at the base of its shaft 40. Preferably, the sleeve 38 is tubular shaped and is formed with a lumen 42 for receiving the shaft 40 of candle 38. With the sleeve 38 in place on the candle 18, the combination can be inserted into a cross-slit 24 without creating unwanted shavings from the candle 18 that could otherwise fall onto the cake 14.

In use, the cake 14 is initially positioned on the tray 16, inside the enclosure 28, with the cover 12 engaged to the tray 16. The sheet 32 is then removed from the support member 22 to expose the cross-slits 24. If used, sleeves 38 are then respectively positioned on the shaft 40 of respective candles 18. The candles 18 are then inserted into the cross-slits 24 of support member 22 and lit. After the honoree has “blown out” the candles 18, the entire cover 12 is removed from the tray 16 and appropriately discarded. The cake 14 can then be consumed by the party goers.

While the particular Protective Food Cover as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A protective food product cover for supporting at least one celebratory candle which comprises:
a hollow sidewall having a top end and a bottom end;
a support member covering the top end of said sidewall to create an enclosure, said support member being formed with at least one cross-slit for receiving a candle therethrough to support the candle on said support member; and
a tray for carrying the food product, the bottom end of said side wall being engageable with said tray to confine the food product in the enclosure and to protect the food product from contamination while the food product is in the enclosure.

2. A food product cover as recited in claim 1 further comprising a sealing means, removably affixed to said support member, for covering the cross-slits thereon and to provide an hermetic seal for the food product in the enclosure.

3. A food product cover as recited in claim 2 wherein said sealing means comprises:
a flexible plastic sheet having a surface; and
an adhesive material positioned on the surface of said plastic sheet to hold said sheet against said support member.

4. A food product cover as recited in claim 1 further comprising a base member connected to said sidewall to position said base member substantially parallel to said support member at a distance therefrom.

5. A food product cover as recited in claim 4 wherein the distance between said base member and said support member is approximately one eighth of an inch.

6. A food product cover as recited in claim 5 further comprising a sealing means, removably affixed to said support member, for covering the cross-slits thereon and to provide an hermetic seal for the food product in the enclosure.

7. A food product cover as recited in claim 1 wherein said sidewall has a circular configuration.

8. A food product cover as recited in claim 1 wherein said sidewall has a rectangular configuration.

9. A food product cover as recited in claim 1 further comprising a tubular shaped sleeve having a lumen for receiving a portion of a candle therein to prevent shaving the candle when the candle, in combination with said sleeve, is inserted into one of the cross-slits in said support member.

10. A food product cover as recited in claim 1 wherein the food product is a birthday cake.

11. A protective food product cover for supporting at least one celebratory candle which comprises:
a means for enclosing the food product in an enclosure, said enclosing means being formed with at least one cross-slit for receiving a candle therethrough to support the candle; and
a sealing means, removably affixed to said support member, for covering the cross-slits thereon to provide an hermetic seal for the food product in the enclosure.

12. A food product cover as recited in claim 11 wherein said enclosing means comprises:
a hollow sidewall having a top end and a bottom end;
a support member covering the top end of said sidewall to create the enclosure, said support member being formed with the cross-slits; and
a tray for carrying the food product, the bottom end of said side wall being engageable with said tray to confine the food product in the enclosure and to protect the food product from contamination while the food product is in the enclosure.

13. A food product cover as recited in claim 12 wherein said sealing means comprises:
a flexible plastic sheet having a surface; and
an adhesive material positioned on the surface of said plastic sheet to hold said sheet against said support member.

14. A food product cover as recited in claim 13 further comprising a base member connected to said sidewall to position said base member substantially parallel to said support member at a distance therefrom.

15. A food product cover as recited in claim 14 wherein the distance between said base member and said support member is approximately one eighth of an inch.

16. A food product cover as recited in claim 15 further comprising a tubular shaped sleeve having a lumen for receiving a portion of a candle therein to prevent shaving the candle when the candle, in combination with said sleeve, is inserted into one of the cross-slits in said support member.

17. A method for using a protective food product cover wherein said food product cover includes a hollow sidewall having a top end and a bottom end with a support member covering the top end of said sidewall to create an enclosure, said support member being formed with at least one cross-slit for receiving a candle therethrough to support the candle on said support member, a tray for carrying the food product, wherein the bottom end of said side wall is engageable with said tray to confine the food product in the enclosure and to protect the food product from contamination while the food product is in the enclosure, and further wherein the food product cover includes a sealing means removably affixed to said support member for covering the cross-slits thereon and to provide an hermetic seal for the food product in the enclosure, said method comprising the steps of:
removing said sealing means from said support member;
inserting a candle into a respective cross-slit on said support member; and
disengaging said sidewall from said tray after said inserting step to remove the food product from the enclosure.

18. A method as recited in claim 17 further comprising the step of providing a tubular shaped sleeve having a lumen for receiving a portion of a candle therein to prevent shaving the candle during said inserting step.

19. A method as recited in claim 17 further comprising the steps of:
lighting the candle after said inserting step; and
blowing out the candle before said disengaging step.

20. A method as recited in claim 17 wherein the food product is a cake.
